(19) United States
(12) Patent Application Publication
(10) Pub. No.: US 2024/0029567 A1
(43) Pub. Date: Jan. 25, 2024

(54) SIGNAL CONTROL SYSTEM AND METHOD FOR REDUCING INTERSECTION ACCIDENTS ON MIXED ROADS WITH AUTONOMOUS VEHICLE

(71) Applicant: KIAPI (Korea Intelligent Automotive Parts Promotion Institute), Daegu (KR)

(72) Inventors: Jong Ho HAN, Daegu (KR); Se Yeong KIM, Daegu (KR); Seong Eun KANG, Daegu (KR); Yun Ki YOON, Incheon (KR); Bong Seob KIM, Daegu (KR); Kyung Su YUN, Daegu (KR)

(21) Appl. No.: 18/224,657

(22) Filed: Jul. 21, 2023

(30) Foreign Application Priority Data
Jul. 22, 2022 (KR) 10-2022-0091160

(51) Int. Cl. G08G 1/16; G08G 1/0967; G08G 1/01

(52) U.S. Cl. CPC G08G 1/164; G08G 1/166; G08G 1/096725; G08G 1/0112

(57) ABSTRACT

A signal control system for reducing intersection accidents on mixed roads with autonomous vehicle includes an autonomous vehicle determining whether there is a possibility of collision based on nearby vehicle information, a signal device installed on a road in a specific area and changing a signal display when a collision possibility notification message is received from the autonomous vehicle, a roadside device installed around the road in the specific area and transmitting and receiving data to and from the autonomous vehicle and the signal device, and an integrated control server transmitting and receiving data to and from the roadside device.

### CROSS-REFERENCE TO RELATED APPLICATION AND CLAIM OF PRIORITY

This application claims the benefit under 35 USC § 119 of Korean Patent Application No. 10-2022-0091160, filed on Jul. 22, 2022, in the Korean Intellectual Property Office, the entire disclosure of which is incorporated herein by reference for all purposes.

### BACKGROUND

### 1. Technical Field

The present disclosure relates to a signal control system and method for reducing intersection accidents on mixed roads with autonomous vehicles.

### 2. Description of the Related Art

Autonomous vehicles are vehicles that may drive automatically without human intervention. Unmanned vehicles drive autonomously by recognizing a surrounding environment and designating a destination.

Unmanned vehicles that are already in practical use include unmanned vehicles operated by the Israeli military to patrol preset routes and unmanned operation systems, such as dump trucks, that are operated at overseas mines or construction sites.

In addition, autonomous vehicles have recently been released as general passenger cars, and demand thereof is expected to increase explosively due to convenience thereof.

Therefore, as autonomous vehicles are introduced to general roads, a new road traffic system and system changes are needed.

However, in the related art, there has been no avoidance technology capable of immediately coping with atypical unexpected situations or disasters on roads where autonomous vehicles and general vehicles are mixed, especially, at intersections.

Accordingly, a technology capable of immediately coping with atypical unexpected situations or disasters on roads where autonomous vehicles and general vehicles are mixed is required.

### SUMMARY

An aspect of the present disclosure is to provide a signal control system and method for reducing intersection accidents on mixed roads with autonomous vehicles, which may immediately cope with atypical unexpected situations or disasters on roads where autonomous vehicles and general vehicles are mixed.

In an aspect, a signal control system for reducing intersection accidents on mixed roads with autonomous vehicles is provided. The signal control system for reducing intersection accidents on mixed roads with autonomous vehicles includes: an autonomous vehicle determining whether there is a possibility of collision based on nearby vehicle information, a signal device installed in a road of a specific area and changing a signal display when a collision possibility notification message is received from the autonomous vehicle, a roadside device installed around the road of the specific area and transmitting and receiving data to and from the autonomous vehicle and the signal device, and an integrated control server transmitting and receiving data to and from the roadside device.

When the collision possibility notification message is received from the autonomous vehicle, the signal device may change the signal display and transmit the changed signal display information to the autonomous vehicle.

The signal device may transmit the changed signal display information to the roadside device, and the roadside device may transmit the changed signal display information to the integrated control server.

In another aspect, a signal control method for reducing intersection accidents on mixed roads with autonomous vehicles is provided. The signal control method for reducing intersection accidents on mixed roads with autonomous vehicles includes: determining, by the autonomous vehicle, whether there is a possibility of collision based on nearby vehicle information; transmitting, by the autonomous vehicle, a collision possibility notification message to a signal device when the autonomous vehicle determines a possibility of collision; and changing a signal display when the signal device receives the collision possibility notification message from the autonomous vehicle, and transmitting changed signal display information to the autonomous vehicle.

The present disclosure may immediately cope with atypical unexpected situations or disasters on roads where autonomous vehicles and general vehicles are mixed.

In addition, the present disclosure may avoid a collision by changing a signal display of a signal device when it is determined that there is a possibility of collision of an autonomous vehicle based on information of a nearby vehicle.

In addition, the present disclosure may prevent traffic congestion in other areas by transmitting changed signal display information to roadside devices in other areas.

### BRIEF DESCRIPTION OF THE DRAWINGS

FIG. 1 is a representative block diagram of a signal control system for reducing intersection accidents on mixed roads with autonomous vehicles according to the present disclosure.

FIG. 2 is a diagram illustrating a signal control system for reducing intersection accidents on mixed roads with autonomous vehicles according to an embodiment.

FIG. 3 is a block diagram of a signal control system for reducing intersection accidents on mixed roads with autonomous vehicles according to an embodiment.

FIG. 4 is a flowchart of a signal control method for reducing intersection accidents on mixed roads with autonomous vehicles according to an embodiment.

FIG. 5 is a diagram illustrating another embodiment.

FIG. 6 is a block diagram of another embodiment.

FIG. 7 is a flowchart of another embodiment.

FIG. 8 is a block diagram of another embodiment.

FIG. 9 is a flowchart of another embodiment.

### DETAILED DESCRIPTION OF THE EMBODIMENTS

In the following detailed description, only certain embodiments of the present disclosure have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification

Throughout the specification, when a part is referred to as “including” a certain element, it means that it may further include other elements rather than exclude other elements, unless specifically indicates otherwise.

Although most terms of elements in this specification have been selected from general ones widely used in the art taking into consideration functions thereof in this specification, the terms may be changed depending on the intention or convention of those skilled in the art or the introduction of new technology. Some terms have been arbitrarily selected by the applicant and their meanings are explained in the following description as needed. Thus, the terms used in this specification should be construed based on the overall content of this specification together with the actual meanings of the terms rather than their simple names or meanings.

It will be understood that, although the terms “first,” “second,” etc. nay be used herein to describe various elements, these elements should not be limited by these terms. These terms are only used to distinguish one element from another. For example, a first element could be termed a second element, and a second element could similarly be termed a first element without departing from the scope of the present disclosure. As used herein, the term “and/or” includes any and all combinations of one or more of the associated listed items.

As used herein, the singular forms “a,” “an,” and “the” are intended to include the plural forms as well, unless the context clearly indicates otherwise.

It will be further understood that the terms “comprises,” “comprising,” “has,” “having,” “includes” and/or “including,” when used herein, specify the presence of stated features, integers, steps, operations, elements, and/or components, but do not preclude the presence or addition of one or more other features, integers, steps, operations, elements, components, and/or groups thereof.

In the description, the word “module” or “unit” refers to a software component, a hardware component, or a combination thereof, which is capable of carrying out at least one function or operation. A plurality of modules or units may be integrated into at least one module and implemented as at least one processor except for those modules or units that need to be implemented in specific hardware.

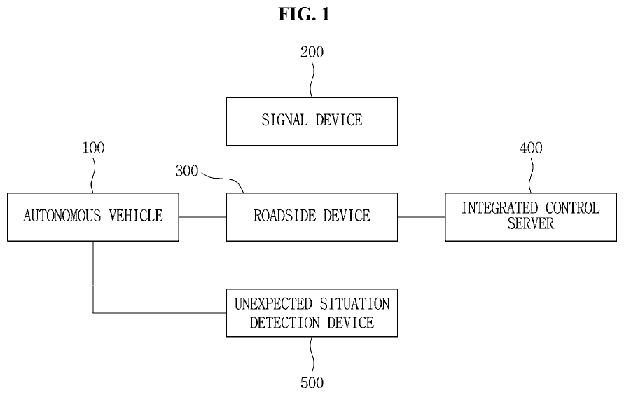

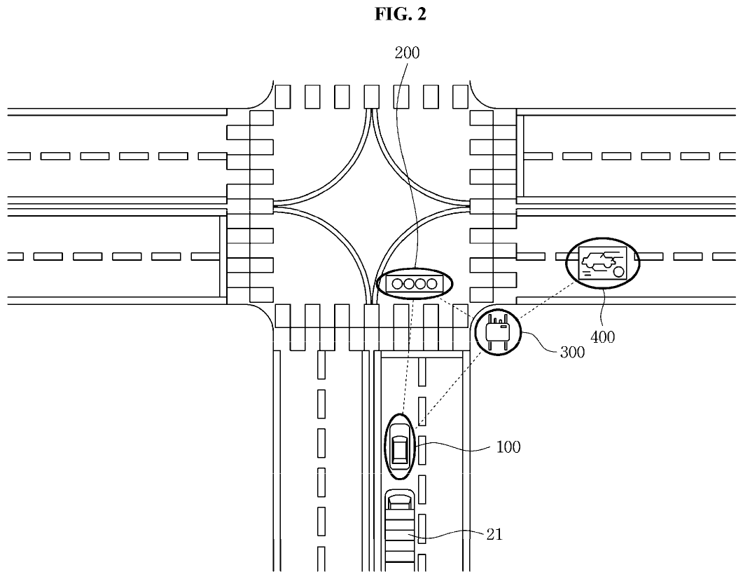

FIG. 1 is a block diagram of a signal control system for reducing intersection accidents on mixed roads with autonomous vehicles according to an embodiment, and FIG. 2 is a diagram illustrating a signal control system for reducing intersection accidents on mixed roads with autonomous vehicles according to an embodiment.

Referring to FIGS. 1 and 2, a signal control system for reducing intersection accidents on mixed roads with autonomous vehicles according to an embodiment includes an autonomous vehicle 100, a signal device 200, a roadside device 300, an integrated control server 400, and an unexpected situation detection device 500.

As an example, the autonomous vehicle 100 may be a vehicle that drives on a road by itself based on various sensor information (e.g., an ego vehicle) without a driver's help.

As an example, the autonomous vehicle 100 may transmit/receive data to/from a nearby vehicle 21, transmit/receive data to/from the signal device 200 (I2V), and transmit/receive data to/from the roadside device 300 (V2I). As an example, the nearby vehicle 21 may be a general vehicle or the autonomous vehicle 100 including a communication module.

As an example, the autonomous vehicle 100 may include a communication module transmitting and receiving data to/from the nearby vehicles 21, the signal device 200, and the roadside device 300 using wireless communication.

As an example, the autonomous vehicle 100 may calculate nearby vehicle information (e.g., speed, relative distance, etc.) through various sensors (e.g., LIDAR, radar, ultrasonic sensor, GPS, image sensor, etc.).

As an example, the autonomous vehicle 100 may determine whether there is a possibility of collision based on nearby vehicle information using a pre-stored artificial intelligence (AI) algorithm.

As an example, the pre-stored AI algorithm may be a machine learning algorithm or a deep learning algorithm.

As an example, the signal device 200 may be installed on a road of a specific area and may include indicators of different colors (e.g., red, orange, and green).

As an example, the signal device 200 may transmit and receive data to and from the autonomous vehicle 100 (I2V) and may transmit and receive data to and from the roadside device 300 (I2I).

As an example, the signal device 200 may include a communication module transmitting and receiving data to and from the autonomous vehicle 100 and the roadside device 300 using wireless communication.

As an example, the signal device 200 may change the display of a signal (e.g., change a red pilot lamp to a green pilot lamp or change an orange pilot lamp ON time) upon receiving a collision possibility notification message from the autonomous vehicle 100. As an embodiment, when the signal device 200 receives a collision possibility notification message from the autonomous vehicle 100 at the time when the autonomous vehicle 100 approaches a stop line, the signal device 200 may change the signal display from the orange pilot light to the green pilot light or maintain the orange pilot lamp ON time for a long period of time.

As an example, the signal device 200 may transmit the changed signal display information to the autonomous vehicle 100. As an example, the autonomous vehicle 100 may set a driving speed and driving direction based on the changed signal display information. For example, when the signal device 200 turns on the orange pilot lamp and a collision possibility situation is determined based on nearby vehicle information at the time when the autonomous vehicle 100 enters an intersection, the autonomous vehicle 100 may travel, rather than stop, by changing a signal display of the signal device 200, thereby avoiding a collision.

As an example, the signal device 200 may transmit the changed signal display information to the roadside device 300.

In addition, the signal device 200 may further include a display device outputting a collision warning message of the integrated control server 400 as another embodiment.

As an example, the roadside device 300 may be installed around a road (or intersection, road work section, etc.) in a specific area, and may be a roadside unit (RSU) that transmits and receives data with all moving vehicles.

As an embodiment, the roadside device 300 may include a communication module transmitting and receiving data with the autonomous vehicle 100, the signal device 200, and the integrated control server 400 using wireless communication.

As an example, the roadside device 300 may transmit the changed signal display information received from the signal device 200 to the integrated control server 400.

The unexpected situation detection device 500, which is at least one of an image detector, a radar sensor, and a LIDAR sensor, may predict a collision between the autonomous vehicle 100 and a nearby vehicle on the road and transmit predicted collision information to the signal device 200 and/or the integrated control server 400.

Upon receiving the changed signal display information from the roadside device 300, the integrated control server 400 may transmit the received signal display information to the roadside device 300 of another area. Through this, traffic congestion in other areas may be prevented.

As an example, the integrated control server 400 may include a communication module transmitting and receiving data with the roadside device 300 using wireless communication.

In addition, as another embodiment, the integrated control server 400 may predict a possibility of collision between a nearby vehicle and the autonomous vehicle 100 through the unexpected situation detection device 500 and output a warning message to the display device.

Also, in another embodiment, the integrated control server 400 may predict a possibility of collision between a nearby vehicle and the autonomous vehicle 100 and transmit information to the autonomous vehicle 100.

In addition, as another embodiment, the integrated control server 400 may predict a possibility of collision between a nearby vehicle and the autonomous vehicle 100 and control the signal device 200 to adjust signal display information.

Through the configuration as described above, the present disclosure may include various embodiments of controlling the autonomous vehicle 100 to avoid the possibility of collision by predicting a possibility of collision of the autonomous vehicle 100 from a viewpoint of the autonomous vehicle 100, a viewpoint of an infrastructure, and a viewpoint of the integrated control server 400 and providing information.

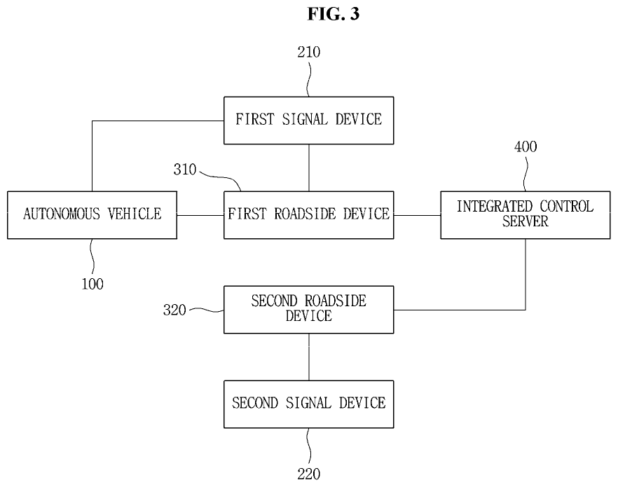

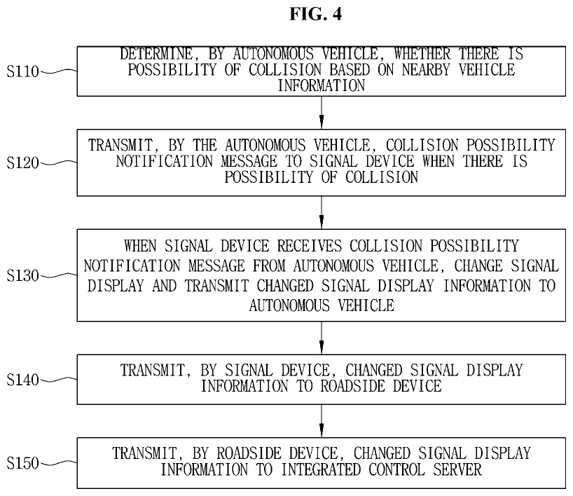

Among them, an embodiment capable of avoiding a collision from the viewpoint of the autonomous vehicle 100 will be described with reference to FIGS. 3 and 4.

FIG. 3 is a block diagram of a signal control system for reducing intersection accidents on mixed roads with autonomous vehicles according to an embodiment.

Referring to FIG. 3, the signal control system for reducing intersection accidents on mixed roads with autonomous vehicles according to an embodiment may include an autonomous vehicle 100, a first signal device 210, a first roadside device 310, a second signal device 220, a second roadside device 320, and an integrated control server 400.

As an example, the autonomous vehicle 100 may be a vehicle that autonomously drives on a road based on various sensor information.

As an example, the first signal device 210 may be installed on a road of an area (e.g., a first intersection) and may display a traffic signal.

As an embodiment, the first roadside device 310 may be installed around a road of an area (e.g., the first intersection) and may transmit and receive data with the autonomous vehicle 100, the first signal device 210, and the integrated control server 400.

As an example, the second signal device 220 may be installed on a road of another area (e.g., a second intersection) and may display a traffic signal.

As an example, the second roadside device 320 may be installed around a road of another area (e.g., the second intersection) and may transmit and receive data with the second signal device 220 and the integrated control server 400.

As an example, the integrated control server 400 may transmit and receive data with the first roadside device 310.

As an example, the autonomous vehicle 100 may determine whether there is a possibility of collision based on nearby vehicle information, and when it is determined that there is a possibility of collision, the autonomous vehicle 100 may transmit a collision possibility notification message to the first signal device 210.

As an example, when a collision possibility notification message is received from the autonomous vehicle 100, the first signal device 210 may change a signal display and transmit the changed signal display information to the autonomous vehicle 100

As an example, the first signal device 210 may transmit the changed signal display information to the first roadside device 310.

As an example, the first roadside device 310 may transmit the changed signal display information to the integrated control server 400.

As an example, the integrated control server 400 may transmit the changed signal display information to the second roadside device 320.

As an example, the second roadside device 320 may transmit the changed signal display information to the second signal device 220.

As an example, the second signal device 220 may change a signal display based on the changed signal display information. Through this, traffic congestion in other areas may be prevented.

FIG. 4 is a flowchart of a signal control method for reducing intersection accidents on mixed roads with autonomous vehicles according to an embodiment.

Referring to FIG. 4, a signal control method for reducing intersection accidents on mixed roads with autonomous vehicles according to an embodiment may include determining whether the autonomous vehicle 100 is in a collision possibility situation based on nearby vehicle information (S110), transmitting, by the autonomous vehicle 100, a collision possibility notification message to the signal device 200, when the autonomous vehicle 100 determines that there is a possibility of collision (S120), changing a signal display and transmitting changed signal display information to the autonomous vehicle 100, when the signal device 200 receives a collision possibility notification message from the autonomous vehicle 100 (S130), transmitting, by the signal device 200, the changed signal display information to the roadside device 300 (S140), and transmitting, by the roadside device 300, the changed signal display information to the integrated control server 400 (S150).

Operations S110 to S150 are the same as the operation of the signal control system for reducing intersection accidents on mixed roads with autonomous vehicles, and thus, detailed descriptions thereof are omitted.

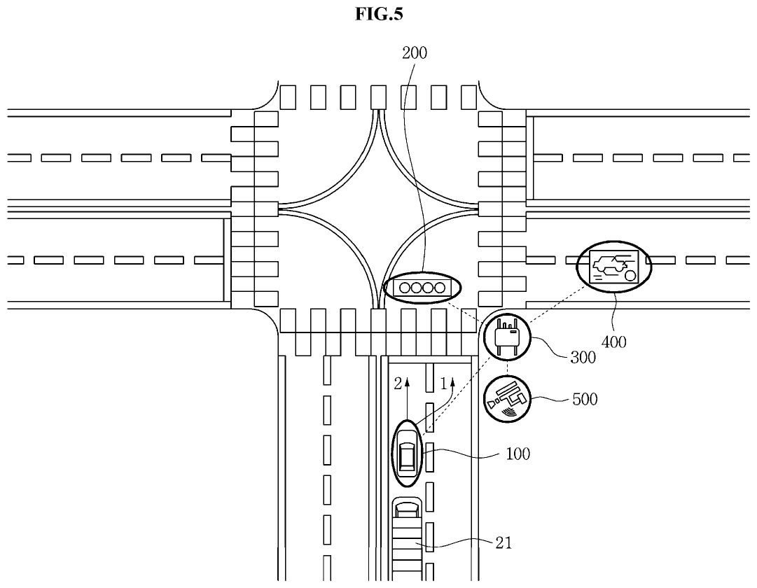

Further, the present disclosure includes another embodiment of controlling avoidance of the autonomous vehicle 100 from a viewpoint of infrastructure, which will be described with reference to FIGS. 5 to 7.

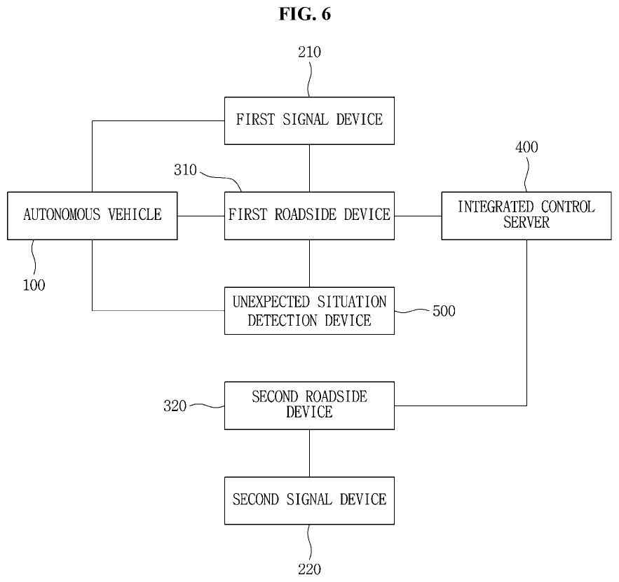

FIG. 5 is an example illustrating a signal control system for reducing intersection accidents on mixed roads with autonomous vehicles according to another embodiment, and FIG. 6 is a block diagram illustrating a signal control system for reducing intersection accidents on mixed roads with autonomous vehicles according to another embodiment.

Referring to FIGS. 5 and 6, another embodiment of the present disclosure may include the autonomous vehicle 100, a first signal device 210, a first roadside device 310, a second signal device 220, and a second roadside device 320, an unexpected situation detection device 500, and the integrated control server 400.

The unexpected situation detection device 500 includes at least one of an image detector, a radar sensor, and a LIDAR sensor, and detects vehicles on the road. The unexpected situation detection device 500 transmits information to the autonomous vehicle 100, the signal device 200, and the integrated control server 400 through the roadside device 300.

For example, the unexpected situation detection device 500 detects the road in real time, and when the autonomous vehicle 100 approaches in one direction, when a nearby vehicle approaches from behind the autonomous vehicle 100, the unexpected situation detection device 500 detects information of the nearby vehicle, such as a speed or a relative distance, predicts a collision possibility, and transmits information (e.g., direction and speed) of the vehicle having a high collision possibility to the first signal device 210 and/or the autonomous vehicle 100.

As an example, the autonomous vehicle 100, as a vehicle that autonomously drives on a road based on various sensor information, performs avoidance control according to the collision possibility information of the unexpected situation detection device 500 through the roadside device 300.

Here, the avoidance control of the autonomous vehicle may be selectively applied according to situations. For example, in the case of a situation in which there is a possibility of collision with a rear vehicle at an intersection, lane change, acceleration, right turn or left turn may be performed, in the case of a situation in which there is a possibility of collision with a front vehicle, deceleration or stop may be performed, or rapid acceleration may be selectively performed according to situations.

The first signal device 210 may be installed on a road, for example, and may display a traffic signal. For example, at an intersection, when information is received from the unexpected situation detection device 500, the first signal device 210 adjusts signal display information to maintain the orange traffic light for a long period of time so that the target autonomous vehicle 100 passes.

The first roadside device 310 may be installed around the road and may transmit and receive data with the autonomous vehicle 100, the first signal device 210, the unexpected situation detection device 500, and the integrated control server 400. That is, the first roadside device 310 transmits the information of the unexpected situation detection device 500 to the first signal device 210 and/or the autonomous vehicle 100, and transmits signal display adjustment information of the first signal device 210 to the integrated control server 400.

The second signal device 220 may be installed on a road in another area (e.g., the second intersection) and may display a traffic signal.

The second roadside device 320 may be installed around the road in another area (e.g., the second intersection) and may transmit and receive data with the second signal device 220 and the integrated control server 400.

The integrated control server 400 may transmit and receive data with the first roadside device 310 and the second roadside device 320. For example, the integrated control server 400 adjusts signal display by controlling the second signal device 220 installed in another area according to the signal display information of the first signal device 210.

That is, the integrated control server 400 may adjust the signal display of the second signal device 220 installed in the other area in order to prevent traffic congestion caused by the adjustment of the signal display of the first signal device 210.

The configuration of the other embodiment as described above is to propose an avoidance technology from the viewpoint of infrastructure that allows the unexpected situation detection device 500 belonging to an infrastructure to determine whether there is a possibility for the autonomous vehicle 100 to collide with a nearby vehicle, and may be combined with an embodiment described above or may be applied alone.

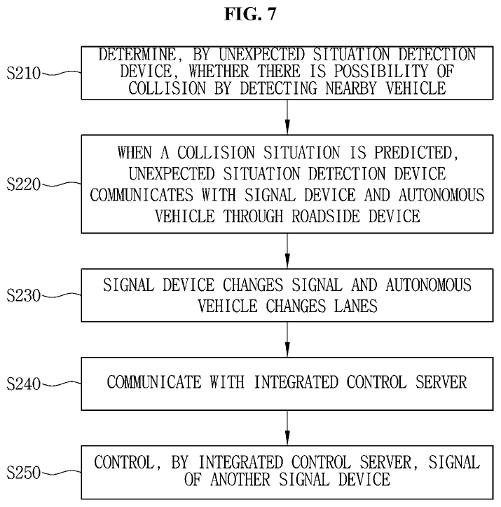

In addition, the present disclosure includes another embodiment of a signal control method for reducing intersection accidents on mixed roads with autonomous vehicles, achieved through the above configurations, which will be described with reference to FIG. 7.

FIG. 7 is a flowchart of a signal control method for reducing intersection accidents on mixed roads with autonomous vehicles according to another embodiment.

Referring to FIG. 7, another embodiment of a signal control method for reducing intersection accidents on mixed roads with autonomous vehicles according to the present disclosure includes operation S210 of determining, by the unexpected situation detection device 500, whether there is a possibility of collision, operation S220 of transmitting information to the signal device 200 and/or the autonomous vehicle 100 through the roadside device 300 when the unexpected situation detection device 500 predicts a collision situation, operation S230 of adjusting, by the signal device 200, a signal display and performing avoidance control by the autonomous vehicle 100, operation S240 of transmitting signal display information to the integrated control server 400, and operation S250 of controlling, by the integrated control server 400, a signal display of the signal device 200 in another area.

Operation S210 is an operation in which the unexpected situation detection device 500 predicts whether the autonomous vehicle 100 will collide with a nearby vehicle. For example, when the autonomous vehicle 100 approaches a nearby vehicle at an intersection, the unexpected situation detection device 500 detects a lane, direction and/or speed of the nearby vehicle to predict the possibility of collision with the autonomous vehicle 100.

Operation S220 is an operation in which the unexpected situation detection device 500 determines that there is a possibility of collision between the autonomous vehicle 100 and the nearby vehicle and transmitting information to the first signal device 210 and/or the autonomous vehicle 100.

For example, the unexpected situation detection device 500 detects the speed and direction of nearby vehicles approaching from the rear before the autonomous vehicle 100 enters the intersection. At this time, a signal of the first signal device 210 is a signal immediately before changing from a blue signal to an orange signal.

Therefore, if the unexpected situation detection device 500 determines that there is a possibility of a collision with a rear vehicle when the autonomous vehicle 100 stops according to a signal, the unexpected situation detection device 500 transmits collision possibility information to the first signal device 210 through the first roadside device 310.

Alternatively, the unexpected situation detection device 500 transmits collision possibility information to the autonomous vehicle.

Operation S230 is an operation in which the first signal device 210 adjusts the signal display. When collision possibility information is received from the unexpected situation detection device 500, the first signal device 210 adjusts the signal of a traffic light (e.g., maintaining a yellow signal, changing a red signal to a blue signal) so that the autonomous vehicle may pass as it is, without being stopped.

Here, when a signal is received from the unexpected situation detection device 500, the autonomous vehicle changes lanes to avoid the vehicle approaching from the rear.

The lane change of the autonomous vehicle or the signal display control of the first signal device 210 may be performed simultaneously or separately.

Operation S240 is an operation in which the unexpected situation detection device 500 and/or the first signal device 210 transmits the information to the integrated control server 400. For example, the first signal device 210 adjusts the signal display and transmits related information to the integrated control server 400 through the first roadside device 310.

Operation S250 is an operation in which the integrated control server 400 transmits a signal display command to the second signal device 220. The second signal device 220 is installed at a next intersection after the intersection where the first signal device 210 is located and changes the signal display according to the change of the signal display of the first signal device 210.

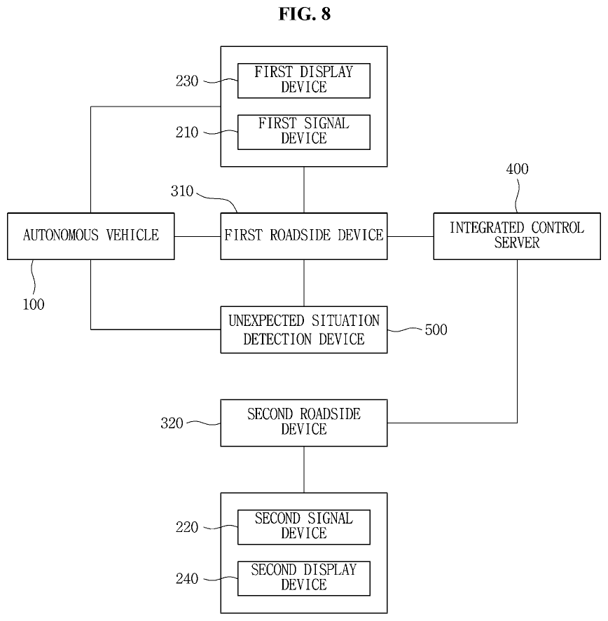

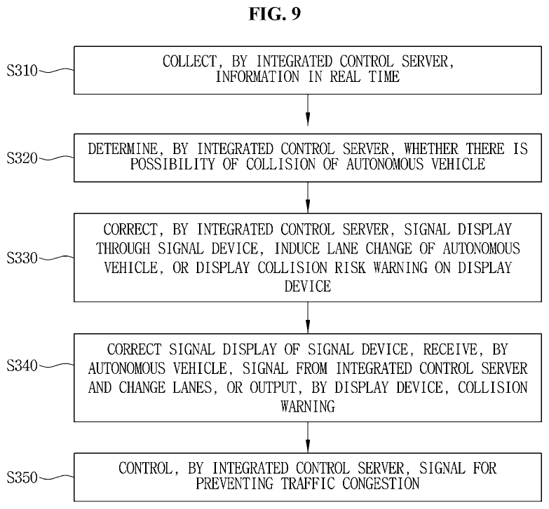

In addition, the present disclosure enables avoidance control of the autonomous vehicle from the viewpoint of the integrated control server 400. This will be described with reference to FIGS. 8 and 9.

FIG. 8 is a block diagram of another embodiment.

Referring to FIG. 8, another embodiment of the present disclosure may include the autonomous vehicle 100, the first signal device 210, a first roadside device 310, the second signal device 220, a second roadside device 320, the unexpected situation detection device 500, and the integrated control server 400.

Here, the first signal device 210 includes a first display device 230 outputting information of the integrated control server 400.

In addition, the second signal device 220 further includes the second display device 240 outputting information of the integrated control server 400.

The unexpected situation detection device 500, which is at least one of a lidar sensor, radar sensor, and image detector, collects information in real time and transmits the collected information to the integrated control server 400.

The integrated control server 400 collects the real-time information from the unexpected situation detection device 500 and calculates the possibility of collision of the autonomous vehicle 100, and if there is a possibility of collision, the integrated control server 400 controls the first display device 230 to notify the autonomous vehicle 100 and the nearby vehicle about collision possibility information and output traffic information of the first signal device 210 to the second display device 240 in real time.

To this end, another embodiment further includes the first display device 230 and the second display device 240 outputting information of the integrated control server 400 in the first signal device 210 and the second signal device 220.

In addition, if there is a possibility of collision, the integrated control server 400 transmits corresponding information to the first signal device 210 and the autonomous vehicle 100 to change the lane of the autonomous vehicle and change the signal display of the first signal device 210 in the embodiment described above.

That is, in another embodiment of the present disclosure, the integrated control server 400 collects information in real time to detect the possibility of collision of the autonomous vehicle 100 and outputs collision possibility information through the first display device 230 or transmits related information to the autonomous vehicle 100 and/or the first signal device 210 to prevent a collision of the autonomous vehicle 100 in advance.

The present disclosure further includes a signal control method for reducing intersection accidents on mixed roads with autonomous vehicles according to another embodiment. This will be described with reference to FIG. 9.

FIG. 9 is a flowchart of a signal control method for reducing intersection accidents on mixed roads with autonomous vehicles according to another embodiment.

Referring to FIG. 9, another embodiment of the present disclosure includes operation S310 of collecting, by the integrated control server 400, information in real time, operation S320 of determining, by the integrated control server 400, whether there is a possibility of collision of the autonomous vehicle 100, operation S330 of transmitting, by the integrated control server 400, information, operation S340 of performing avoidance control by at least one of the signal device 200, a display device and/or the autonomous vehicle 100, and operation S350 of controlling, by the integrated control server 400, the signal device 200 of another area to prevent a traffic congestion.

Operation S310 is an operation in which the integrated control server 400 collects information in real time. The unexpected situation detection device 500 including at least one of an image detector, a LiDAR sensor, and a radar sensor detects information, such as a position, speed, direction, and the like of a vehicle on the road, and transmits the information to the integrated control server 400 through the first roadside device 310.

In addition, the first signal device 210 transmits signal display information, such as a signal change and/or maintenance to the integrated control server 400 in real time through the first roadside device 310.

Accordingly, the integrated control server 400 may collect information from the unexpected situation detection device 500 and the first signal device 210 in real time.

Operation S320 is an operation in which the integrated control server 400 analyzes the collected information in real time to detect a possibility of collision of the autonomous vehicle 100. The integrated control server 400 detects whether there is a possibility of collision between the autonomous vehicle 100 and a nearby vehicle based on the information collected in real time from the unexpected situation detection device 500 and/or the first signal device 210.

Operation S330 is an operation in which the integrated control server 400 transmits collision possibility information by controlling the signal device 200 and the autonomous vehicle 100 and/or the display device, when a possibility of collision of the autonomous vehicle is detected. Here, the integrated control server 400 informs the autonomous vehicle 100 that there is a possibility of collision to induce avoidance control (e.g., lane change, deceleration, acceleration, or stop) of the autonomous vehicle 100 under conditions set according to situations.

In addition, the integrated control server 400 transmits collision possibility information to the first signal device 210 to change the signal display.

In addition, the integrated control server 400 may warn a nearby vehicle of a to possibility of collision through the first display device 230.

Information may be collectively or selectively transmitted from the integrated control server 400 to the autonomous vehicle 100, the first signal device 210, and the first display device 230.

Operation S340 is an operation in which the first signal device 210 receives a signal from the integrated control server 400 and adjusts (corrects) the signal display.

Alternatively, operation S340 is an operation in which the autonomous vehicle 100 receives a signal from the integrated control server 400 through the first roadside device 310 and performs avoidance control (e.g., lane change or acceleration) of a nearby vehicle.

Alternatively, operation S340 is an operation in which the first display device 230 receives a signal from the integrated control server 400 and outputs a message warning the autonomous vehicle 100 and/or a nearby vehicle of a collision.

That is, operation S340 is an operation in which at least one of the autonomous vehicle 100, the first signal device 210, and the first display device 230 receiving the signal from the integrated control server 400 performs avoidance control to avoid a collision.

Operation S350 is an operation in which the integrated control server 400 corrects a traffic signal or outputs a message through at least one of the second signal device 220 and the second display device 240 installed at a next intersection connected to prevent traffic congestion in other areas connected to the site.

As such, the present disclosure proposes a technology for preventing collisions at intersections where autonomous vehicles are mixed from the viewpoint of the autonomous vehicle, from the viewpoint of the infrastructure, and from the viewpoint of the integrated control server.

In addition, there is no difficulty in applying the present disclosure to a real situation by mixing at least one of the viewpoints of the autonomous vehicle, the infrastructure, and the integrated control server 400, and as a result, collision accidents may be reliably prevented in advance in areas where mixed road conditions, such as intersections, are prevalent.

The embodiments of the present disclosure have been described in detail, but the scope of the present disclosure is not limited thereto and various variants and modifications by a person skilled in the art using a basic concept of the present disclosure defined in claims also belong to the scope of the present disclosure.

It will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present disclosure.

What is claimed is:

1. A signal control system for reducing intersection accidents on mixed roads with autonomous vehicle, the signal control system comprising:
an autonomous vehicle determining whether there is a possibility of collision based on nearby vehicle information;
a signal device installed on a road in a specific area and changing a signal display when a collision possibility notification message is received from the autonomous vehicle;
a roadside device installed around the road in the specific area and transmitting and receiving data to and from the autonomous vehicle and the signal device; and
an integrated control server transmitting and receiving data to and from the roadside device.

2. The signal control system of claim 1, wherein, when the collision possibility notification message is received from the autonomous vehicle, the signal device changes the signal display and transmits changed signal display information to the autonomous vehicle.

3. The signal control system of claim 2, wherein the signal device transmits the changed signal display information to the roadside device, and
the roadside device transmits the changed signal display information to the integrated control server.

4. A signal control system for reducing intersection accidents on mixed roads with autonomous vehicle, the signal control system comprising:
an autonomous vehicle;
an unexpected situation detection device installed on a road in a specific area and detecting a collision possibility situation of a nearby vehicle;
a signal device installed on the road in the specific area and changing a signal display when collision possibility information is received from the unexpected situation detection device;
a roadside device installed around the road in the specific area and transmitting and receiving data to and from at least one of the unexpected situation detection device, the autonomous vehicle, and the signal device; and
an integrated control server transmitting and receiving data to and from the roadside device.

5. The signal control system of claim 4, wherein, when the collision possibility information is received from the unexpected situation detection device, the signal device changes the signal display and transmits changed signal display information to at least one of the autonomous vehicle and the integrated control server.

6. The signal control system of claim 5, wherein the signal device transmits the changed signal display information to the integrated control server through the roadside device.

7. A signal control system for reducing intersection accidents on mixed roads with autonomous vehicle, the signal control system comprising:
an autonomous vehicle;
an unexpected situation detection device collecting road conditions in a specific area in real time;
a signal device installed on a road in the specific area to change a signal display;
a roadside device installed around the road in the specific area and transmitting and receiving data to and from at least one of the unexpected situation detection device, the autonomous vehicle, and the signal device; and
an integrated control server collecting road information in the specific area in real time through the roadside device, detecting a collision possibility situation, and transmitting collision possibility information to at least one of the signal device and the autonomous vehicle;

8. The signal control system of claim 7, wherein, when the collision possibility information is received from the integrated control server, the signal device changes the signal display and transmits changed signal display information to at least one of the autonomous vehicle and the integrated control server.

9. The signal control system of claim 7, wherein, when the collision possibility information is received from the integrated control server, the autonomous vehicle changes lanes, accelerates, decelerates, or stops.

10. The signal control system of claim 7, further comprising:
a display device installed around the road in the specific area, receiving collision possibility information from the integrated control server, and outputting a warning message.

11. A signal control method for reducing intersection accidents on mixed roads with autonomous vehicle, the signal control method comprising:
determining, by an autonomous vehicle, whether there is a possibility of collision based on nearby vehicle information;
transmitting, by the autonomous vehicle, a collision possibility notification message to a signal device when there is a possibility of collision;
when the signal device receives the collision possibility notification message from the autonomous vehicle, changing a signal display and transmitting changed signal display information to the autonomous vehicle;
transmitting, by the signal device, the changed signal display information to the roadside device;
transmitting, by the roadside device, the changed signal display information to an integrated control server; and
controlling, by the integrated control server, the signal device of another area to correct the signal display.

12. A signal control method for reducing intersection accidents on mixed roads with autonomous vehicle, the signal control method comprising:
detecting, by an unexpected situation detection device including at least one of a LiDAR sensor, a radar sensor, and an image detector on a road in a specific area, a collision possibility situation of a nearby vehicle;
detecting, by the unexpected situation detection device, a collision possibility situation and transmitting collision possibility information to a signal device;
when the signal device receives a collision possibility notification message from the autonomous vehicle, changing a signal display and transmitting changed signal display information to the autonomous vehicle;
transmitting, by the signal device, the changed signal display information to a roadside device;
transmitting, by the roadside device, the changed signal display information to an integrated control server; and
controlling, by the integrated control server, the signal device of another area to correct the signal display.

13. A signal control method for reducing intersection accidents on mixed roads with autonomous vehicle, the signal control method comprising:
collecting, by an integrated control server, information detected from a road in a specific area in real time;
detecting, by the integrated control server, whether there is a possibility of collision of a nearby vehicle based on the information collected in real time;
when a collision possibility situation of the nearby vehicle is detected based on the information collected by the integrated control server, transmitting collision possibility information to at least one of a signal device, an autonomous vehicle, and a display device in a corresponding area;
performing a collision avoidance process, by at least one of the signal device, the autonomous vehicle, and the display device, upon receiving the collision possibility situation information from the integrated control server; and
outputting, by the integrated control server, a signal display and traffic information to at least one of the signal device and the display device of the other area,
wherein, in the operation of performing the collision avoidance process,
the signal device corrects the signal display,
the autonomous vehicle operates with a vehicle avoidance action set as one of lane change, acceleration, and deceleration, and
the display device outputs a collision possibility message to a nearby car.
